(19) United States
(12) Patent Application Publication
(10) Pub. No.: US 2010/0248884 A1
(43) Pub. Date: Sep. 30, 2010

(54) Transmission for an Electrically Powered Vehicle

(76) Inventor: Richard Tremblay, Weare, NH (US)

Correspondence Address: Russ Weinzimmer, 614 Nashua Street, Suite 53, Milford, NH, 03055, US

(21) Appl. No.: 12/415,990

(22) Filed: Mar. 31, 2009

(51) Int. Cl. F16H 57/08; F16H 3/44; F16H 63/02

(52) U.S. Cl. 475/138; 475/269; 475/303

(57) ABSTRACT

A simple, lightweight transmission for use in an electrically powered vehicle is disclosed. The transmission is symmetric in both weight and power distribution, and provides two input-to-output gear ratios, a neutral setting, and a park setting. A single “dog” clutch operates in splined relationship with a first shaft, and a single planetary gear assembly is connected to a second shaft. Sliding the dog clutch among four positions serves to shift the transmission among direct shaft engagement for direct drive, engagement through the planetary gear assembly for overdrive, disengagement for neutral, and double engagement for park. Preferred embodiments include reduction gears in the planetary gear assembly. Other embodiments include a synchronizer so as to synchronize the shaft rotation speeds when they are not exactly matched. Further embodiments include a dual-servo shift mechanism that prevents shifting into park unless a park servo is in its park position.

### FIELD OF THE INVENTION

The invention generally relates to transmissions for motor vehicles, and more specifically to transmissions for electrically powered motor vehicles.

### BACKGROUND OF THE INVENTION

Nearly every motor vehicle that is powered by an internal combustion engine includes a transmission, or “gear box.” The transmission serves to modify the RPM (revolutions per minute) ratio between the engine's drive shaft and the wheels, so as to allow the vehicle to travel at any of a wide variety of speeds while at the same time allowing the internal combustion engine to operate within a narrow RPM range that provides for optimal torque and efficiency.

A transmission typically includes a plurality of gears that can be mechanically engaged and disengaged in different combinations (“shifted”) so as to produce a variety of different input to output RPM ratios, or “speeds.” A transmission typically can be shifted into more than one “forward speed,” as well as into a reverse setting that allows the vehicle to move backward, and a “neutral” setting that allows the vehicle to remain standing while the engine continues to operate. Manual transmissions are physically shifted by a driver among speeds, while automatic transmissions can be set to shift among all forward speeds automatically. In addition to forward speeds, reverse, and neutral, an automatic transmission typically also provides a “park” setting that locks the transmission and prevents the wheels from turning.

A transmission used with an internal combustion engine typically also includes a friction clutch that serves to connect and disconnect the motor from the transmission, thereby allowing the transmission to be shifted and then re-synchronized with the motor. Manual transmissions typically include a manually operated, dry friction clutch, while automatic transmissions typically include a series of fluid-operated wet clutches that are automatically actuated by a combination of hydraulics and electronic logic circuits.

Motor vehicles that are powered by electric motors often do not include a transmission or a clutch. This is because an electric motor can typically be operated over a wide range of speeds with substantially uniform torque and efficiency, can be stopped as needed, and can be operated in both directions, allowing for backward motion simply by reversing the direction or changing the phase of the electrical current supplied to the motor. However, sometimes the desired maximum speed of an electrically powered vehicle exceeds the maximum operating speed of the electric motor. Also, it can be desired to have a “park” feature so as to immobilize an electric vehicle, as is normally provided by a conventional automatic transmission.

One approach is to equip an electrically powered vehicle with a conventional manual or automatic transmission and friction clutch. However, this approach provides more forward speeds than are needed, while adding unnecessary weight, complexity, and expense to the vehicle, reducing its performance, reducing its reliability, and reducing its operating range.

Specially designed transmissions with only two forward speeds have been proposed for electrically powered vehicles, but they also typically add an undesirable amount of weight, complexity, and cost to the vehicle, and they typically lack a “park” feature, as well as lacking the symmetry of weight and power distribution commonly found in conventional transmissions. Proposed electric vehicle transmissions also typically require a friction clutch, which further increases the weight and adds to the cost of manufacture, and adds to the repair and maintenance expense.

### SUMMARY OF THE INVENTION

A simple, lightweight transmission for use in an electrically powered vehicle is claimed. The transmission of the invention provides two input-to-output gear ratios, a neutral setting, and a park setting, and is symmetric in both weight and power distribution. The transmission includes a single “dog” clutch in splined relationship with a first shaft, and a single planetary gear assembly connected to a second shaft. According to the invention, a friction clutch is not required, since the shaft speeds can be electronically matched and/or matched by a synchronizer.

Shifting among the four included speeds is accomplished by sliding the dog clutch along the first shaft among four positions, thereby causing the first shaft to directly engage the second shaft (called the “direct drive” setting), or engage the second shaft by means of the planetary gear assembly (called the “overdrive” setting), or not engage the second shaft at all (called the “neutral” setting), or engage the second shaft both directly and by means of the planetary gear assembly, thereby preventing any motion of the either shaft (called the “park” setting).

In certain preferred embodiments, reduction gears are included in the planetary gear assembly to further adjust the gear ratio of the overdrive setting. The transmission of the present invention can be implemented with the first shaft coupled to the motor and the second shaft coupled to the drive wheels, or vice-versa.

In preferred embodiments, a dual-servo shift controller is included. In these embodiments, a shift servo shifts the dog clutch among the drive, neutral, and overdrive settings when the park servo is in its “run” position, while the dog clutch can only be moved to the park setting when the park servo is in its “park” position. In some of these embodiments, the park servo is configured so as to remain in the run position if a malfunction such as an electrical control signal fault occurs while the park servo is in the run position. In other of these embodiments, the dual-servo shift controller includes safety control features that prevent the park servo from moving to the park position if the vehicle is moving.

The present invention is a transmission for use with an electrically powered vehicle, the transmission. The transmission includes a first shaft, a second shaft collinear with the first shaft and separated from the first shaft by a gap, a planetary gear assembly rotationally engaged with the second shaft, and a dog clutch in splined relationship with the first shaft, the dog clutch being movable among a plurality of positions along a length of the first shaft while remaining rotationally engaged with the first shaft, the dog clutch thereby engaging the first shaft with the second shaft in various rotational speed relationships in accordance with the position of the dog clutch.

In preferred embodiments, the dog clutch is able to move along the length of the first shaft so as to:

in a drive position, engage with the second shaft so as to cause the second shaft to rotate at the same speed as the first shaft;

in an overdrive position, engage with the planetary gear assembly, thereby engaging with the second shaft according to a gear ratio established by the planetary gear assembly, and thereby causing the second shaft to rotate at a speed that is different from the rotational speed of the first shaft; and

in a neutral position, not engage with the second shaft, thereby providing no rotational engagement between the first shaft and the second shaft.

And in some of these preferred embodiments, the dog clutch is further able to move along the length of the first shaft so as to:

in a park position, rotationally engage with the second shaft both directly and through the planetary gear assembly, thereby preventing rotation of both the first shaft and the second shaft.

In preferred embodiments, the dog clutch is able to engage with the second shaft by spline engagement when in at least one of the drive position and the park position. In some preferred embodiments, the dog clutch includes a drive gear and a park gear, the drive gear being configured so as to engage with the planetary gear assembly when the dog clutch is in the overdrive position, the park gear being configured so as to engage with the planetary gear assembly when the dog clutch is in the park position.

Other preferred embodiments further include a drum that is rotationally engaged with the second shaft, and configured so as to engage with the drive gear when the dog clutch is in the drive position and when the dog clutch is in the park position.

In certain preferred embodiments, the first shaft is drivable by a motor of the electrically powered vehicle, and the second shaft is able to drive at least one wheel of the electrically powered vehicle. And in various preferred embodiments the second shaft is drivable by a motor of the electrically powered vehicle, and the first shaft is able to drive at least one wheel of the electrically powered vehicle.

In preferred embodiments the planetary gear assembly includes reduction gears. In some preferred embodiments the weight of the transmission is distributed in a substantially symmetric manner about the first and second shafts. In some preferred embodiments the power distribution of the transmission is substantially symmetric about the first and second shafts.

In other preferred embodiments the planetary gear assembly includes a plurality of planetary gears, the planetary gears being positioned within a concentric gap located between a sun gear fixed to the second shaft and an immovable ring gear symmetrically surrounding the sun gear, the planetary gear assembly being engaged with the second shaft by simultaneous engagement of the planetary gears with both the sun gear and the ring gear.

Certain preferred embodiments further include a synchronizer that is able to synchronize the rotational speeds of the first and second shafts by applying a frictional torque to the first and second shafts until their rotational speeds are matched, thereby facilitating transition of the dog clutch to either of the drive and overdrive positions. In some of these embodiments the transmission includes a drum that is rotationally engaged with the second shaft, a planet carrier that is rotationally engaged with the planetary gear set, a first synchronizer ring that is frictionally engaged with the drum, the first synchronizer ring being rotationally engageable with the dog clutch so as to apply friction to the drum when the dog clutch and the drum are rotating at different speeds, thereby applying a frictional torque to both the dog clutch and to the drum that tends to equalize the rotational speeds of the dog clutch and the drum, and a second synchronizer ring that is frictionally engaged with the planet carrier, the second synchronizer ring being rotationally engageable with the dog clutch so as to apply friction to the planet carrier when the dog clutch and the planet carrier are rotating at different speeds, thereby applying a frictional torque to both the dog clutch and to the planet carrier that tends to equalize the rotational speeds of the dog clutch and the planet carrier.

In some of these embodiments, at least one of the synchronizer rings is made from a synchronizer material that is selected so as to minimize frictional wear to cooperative elements in the transmission. And in some of these embodiments the synchronizer material is brass.

Preferred embodiments further include a dual-servo shift controller. The dual-servo shift controller includes a shift servo that is able to move a shift rod linearly among a first shift position, a second shift position, and a third shift position, the movement of the shift rod being parallel to both the first and second shafts, a park servo that is able to move a park rod linearly between a park position and a run position, the movement of the park rod being parallel to both the first and second shafts, and a cross-brace having a first end attached to the shift rod, a second end attached to the park rod, the dog clutch being attached to the cross-brace at a clutch attachment point located between the first end and the second ends, the shift servo, park servo, and cross-brace being configured so as to move the dog clutch among the drive position, the overdrive position, and the neutral position when the shift servo is moved among the shift positions and the park servo is held in the run position, the shift servo, park servo, and cross-brace being configured so as to allow the dog clutch to be moved to the park position only when the park servo is in the park position.

In some of these embodiments the dog clutch is moved to the drive position when the shift rod is in the first shift position and the park rod is in the run position, the dog clutch is moved to the neutral position when the shift rod is in the second shift position and the park rod is in the run position, the dog clutch is moved to the overdrive position when the shift rod is in the third shift position and the park rod is in the run position and the dog clutch is moved to the park position when the shift rod is in the first shift position and the park rod is in the park position.

In other of these embodiments the park servo is configured so as to remain in its run position if the park servo is in its run position and a transmission malfunction occurs. And still other of these embodiments further include at least one safety feature that is configured so as to inhibit the park rod from moving to the park position if the electrically powered vehicle is moving.

### BRIEF DESCRIPTION OF THE DRAWINGS

The invention will be more fully understood by reference to the detailed description, in conjunction with the following figures, wherein:

FIG. 1A is a cross sectional view of a preferred embodiment of the present invention, shown in its “neutral” setting;

FIG. 1B is a cross sectional view taken at right angles to the cross section of FIG. 1A through the ring and planetary gears;

FIG. 1C is a cross sectional view of taken at right angles to the cross section of FIG. 1A through a gear attached to the dog clutch;

FIG. 1D is a transparent, perspective drawing of the planetary gear assembly of FIG. 1A;

FIG. 1E is an opaque, perspective drawing of the planetary gear assembly of FIG. 1A;

FIG. 1F is a transparent, perspective view of a planetary gear assembly from an embodiment similar to FIG. 1A that includes three planetary gears in the planetary gear assembly;

FIG. 2A is a cross sectional view of the embodiment of FIG. 1A shown in its “direct drive” setting;

FIG. 2B is a cross sectional view of the embodiment of FIG. 1A in its “overdrive” setting;

FIG. 2C is a cross sectional view of the embodiment of FIG. 1A in its “park” setting;

FIG. 3 is a cross sectional view of an embodiment similar to the embodiment of FIG. 1A but including reduction gears in the planetary gear assembly, the embodiment being shown in its overdrive setting;

FIG. 4A is a cross sectional view of a preferred embodiment similar to the embodiment of FIG. 3, but including a synchronizer embodied within a drum assembly, the embodiment being shown with the dog clutch and first shaft removed from the transmission;

FIG. 4B is a cross sectional view of the embodiment of FIG. 4A in its “neutral” setting;

FIG. 4C is a cross sectional view of the embodiment of FIG. 4A in its “direct drive” setting;

FIG. 4D is a cross sectional view of the embodiment of FIG. 4A in its “overdrive” setting;

FIG. 4E is a cross sectional view of the embodiment of FIG. 4A in its “park” setting;

FIG. 5A is a side illustration of a dual-servo shift controller in a preferred embodiment, shown in its overdrive setting;

FIG. 5B is a side illustration of the dual-servo shift controller of FIG. 5A, shown in its neutral setting;

FIG. 5C is a side illustration of the dual-servo shift controller of FIG. 5A, shown in its drive setting;

FIG. 5D is a side illustration of the dual-servo shift controller of FIG. 5A, shown in its park setting;

### DETAILED DESCRIPTION OF PREFERRED EMBODIMENTS

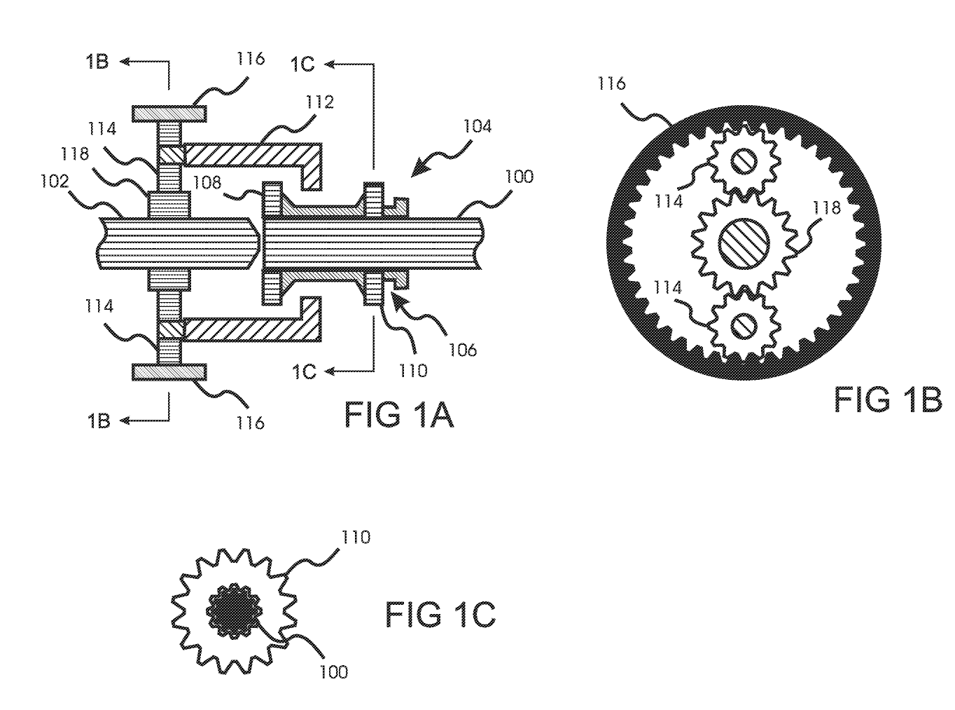

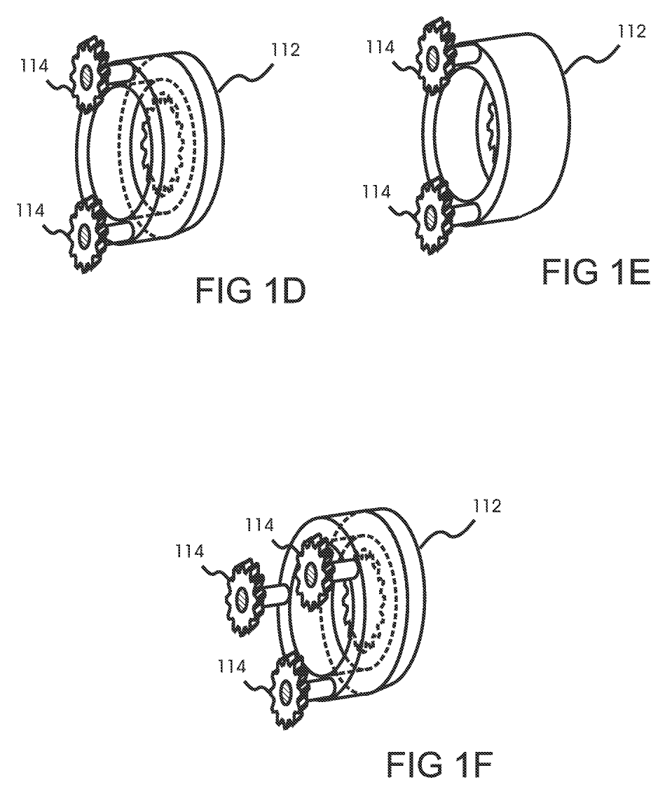

With reference to FIG. 1A, the transmission of the present invention includes a first shaft 100 and a second shaft 102 that are co-linear with each other and separated by a small gap. In various implementations, either the first shaft is driven by the motor and the second shaft drives the wheels, or the second shaft is driven by the motor and the first shaft drives the wheels. A “dog clutch” 104 operates in splined relationship with the first shaft 100, so that it can move along the length of the first shaft 100, but must remain fixed to the first shaft 100 in its rotational orientation. The second shaft 102 also includes spline teeth, so as to enable the dog clutch 104 to engage with the second shaft 102 when the dog clutch 104 is moved so as to extend across the gap between the first shaft 100 and the second shaft 102.

The dog clutch 104 includes a “shift pin groove” 106 that allows for attachment of a shifting mechanism (not shown) that moves the dog clutch 104 along the first shaft 100 according to the desired speed setting of the transmission. The dog clutch 104 also includes an drive gear 108, and a park gear 110 that are fixed to the dog clutch 104 and are able to engage with the planet carrier 112 of a planetary gear assembly. In the embodiment of FIG. 1A, the planet carrier 112 supports two planetary gears 114, while in similar embodiments three or more planetary gears 114 are included. The planetary gears 114 are engaged with an immovable ring gear 116 and with a sun gear 118 that is fixed to the second shaft 102.

The engagement of the planetary gears 114 with the ring gear 116 and the sun gear 118 is illustrated in the cross sectional drawing of FIG. 1B. Because the ring gear 116 is not movable, rotation of the planet carrier 112 causes rotation of the planet gears 114 which leads to rotation of the sun gear 118 and of the second shaft 102. For example, according to FIG. 1B, if the planet carrier 112 is rotated in a clockwise direction, the planet gears 114 are caused to move in a clockwise pattern about the second shaft 102. The engagement of the planet gears 114 with the ring gear 116 causes the planet gears 114 to rotate in a counterclockwise direction as they move, and this in turn causes the sun gear 118 and the second shaft 102 to rotate in a clockwise direction.

FIG. 1C is a cross section through the park gear 110 attached to the dog clutch 104. The figure illustrates the splined engagement between the dog clutch 104 and the first shaft 100.

FIG. 1D is a transparent, perspective view of the planetary gear assembly of FIG. 1A, showing the planet carrier 112 and the two planet gears 114. FIG. 1E presents the same view of the planetary gear assembly of FIG. 1A, but shown as an opaque, perspective view. FIG. 1E is a transparent, perspective view of a planetary gear assembly similar to FIG. 1D but including three planetary gears 114 instead of only two.

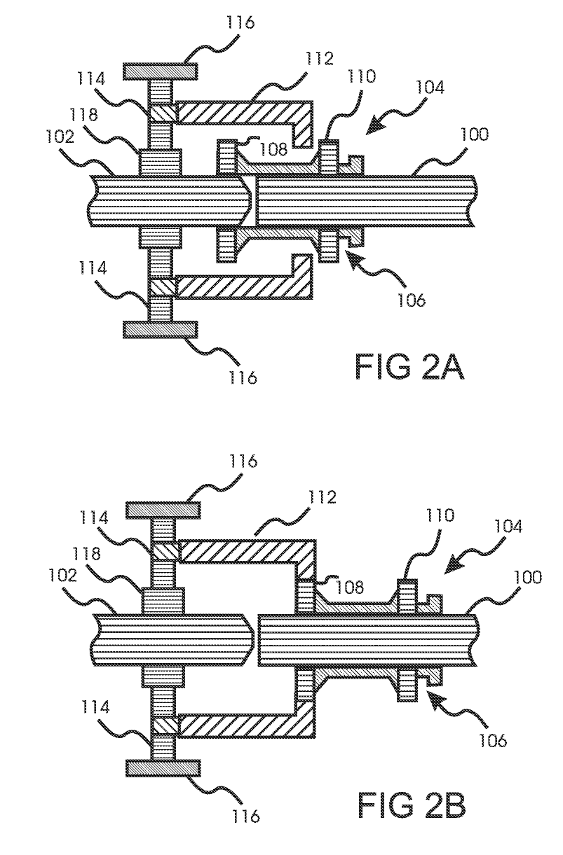

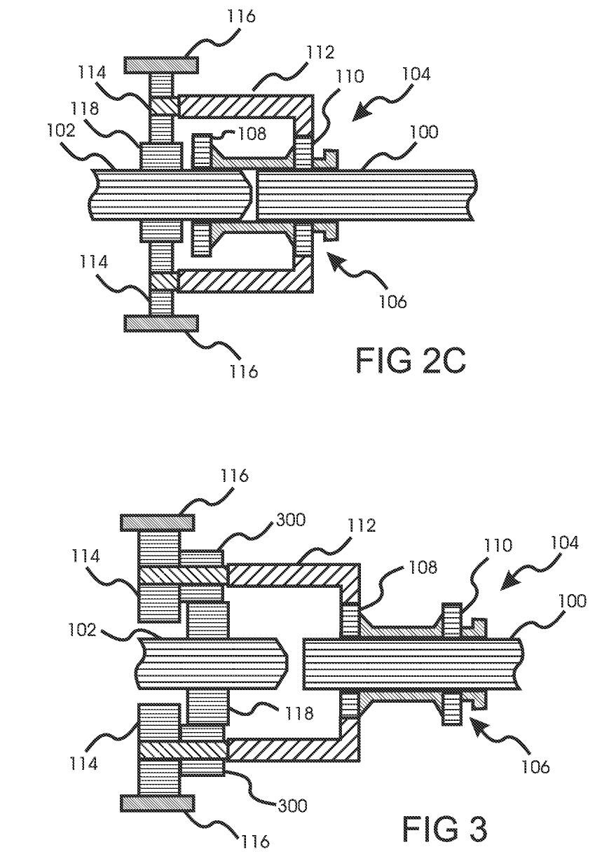

In FIG. 1A, the dog clutch 104 is shown in its “neutral” position, since it is engaged only with the first shaft 100. In FIG. 2A, the dog clutch 104 is shown in its “direct drive” position, having been moved along the first shaft 100 so as to bridge the gap between the first shaft 100 and the second shaft 102, being thereby in splined engagement with both shafts 100, 102. While the dog clutch 104 is in this position, rotation of either shaft 100, 102 will cause the other shaft 102, 100 to rotate at the same rate.

In FIG. 2B the dog clutch 104 is shown in its “overdrive” position, wherein one of the gears 108 attached to the dog clutch 104 is engaged with the planet carrier 112. While the dog clutch is in this position, rotation of the first shaft 100 will cause the planetary gear assembly to rotate, ultimately causing the second shaft 102 to rotate at a rate determined by the gear ratios of the dog clutch drive gear 108, the planet carrier 112, the planet gears 114, the ring gear 116, and the sun gear 118. Similarly, rotation of the second shaft will cause the first shaft to rotate at a rate dictated by the same gear ratios in reverse.

In FIG. 2C, the dog clutch 104 is shown in its “park” configuration, wherein the dog clutch 104 is engaged directly with both the first 100 and second 102 shafts, while the dog clutch 104 is simultaneously engaged with the second shaft 102 through the planetary gear assembly, due to engagement between the planet gear 112 and the park gear 110 attached to the dog clutch 104. This dual coupling between the first and second shafts prevents any motion of either shaft.

FIG. 3 is a cross sectional drawing that illustrates an embodiment similar to the embodiment of FIG. 1A, but including additional “reduction” gears 300 that further adjust the gear ratios between the first 100 and second 102 shafts when the dog clutch 104 is in the “overdrive” position, as shown.

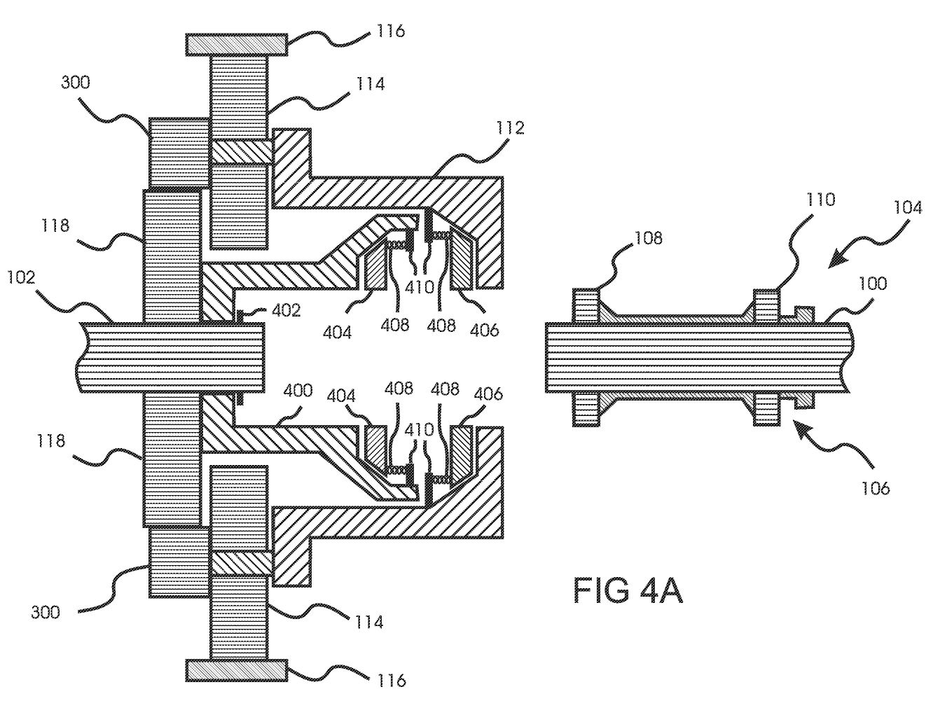

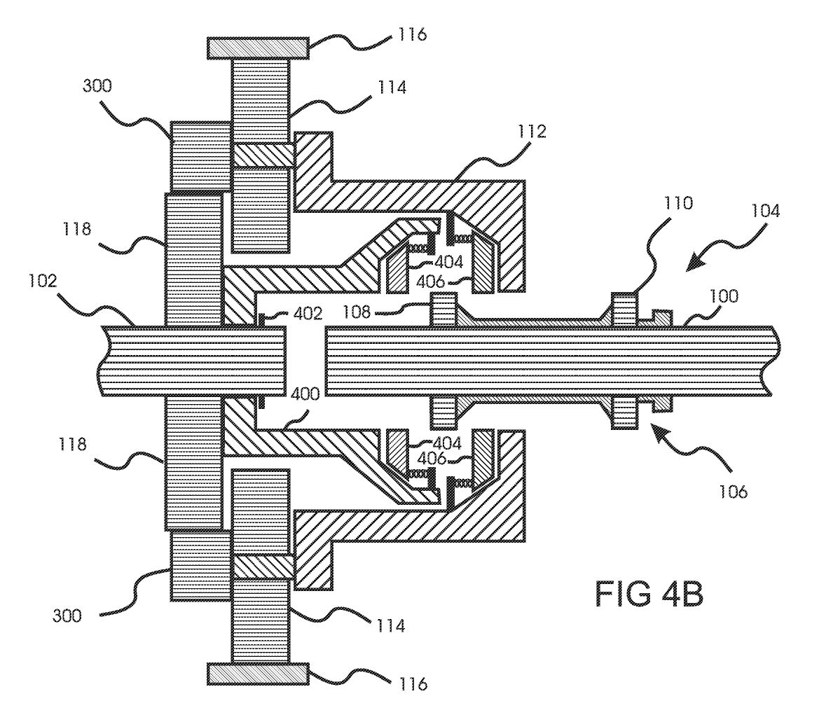

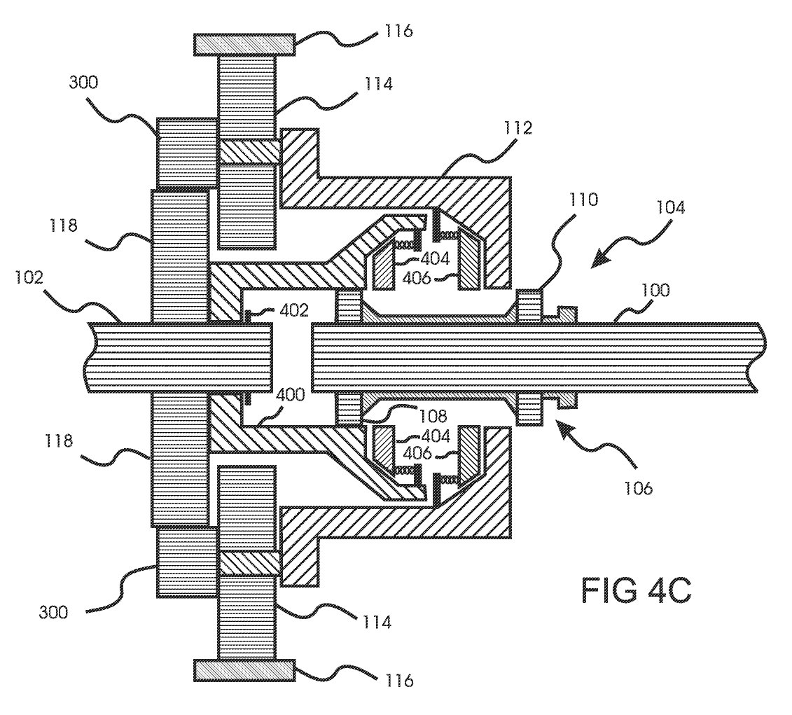

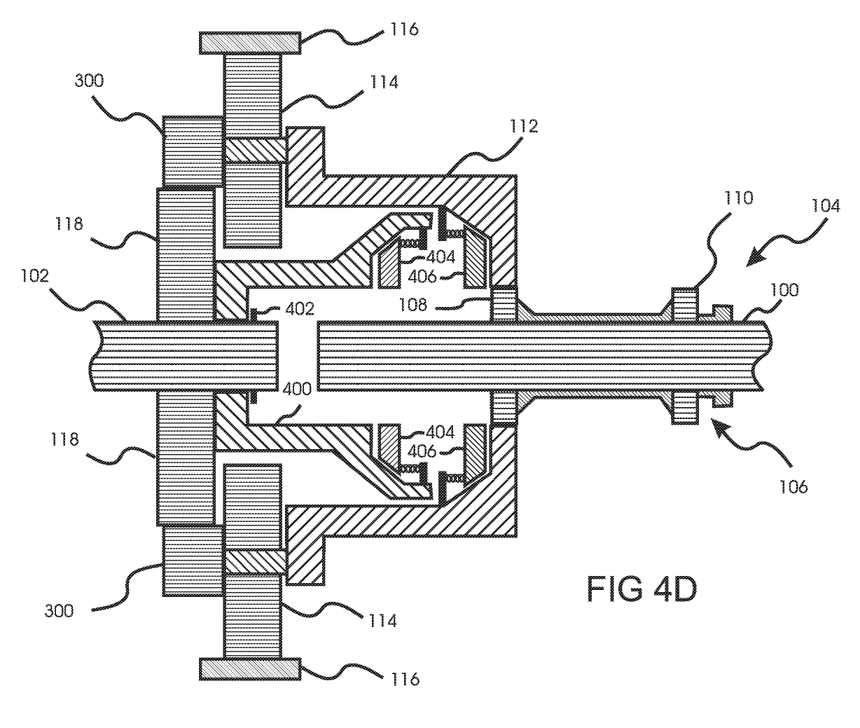

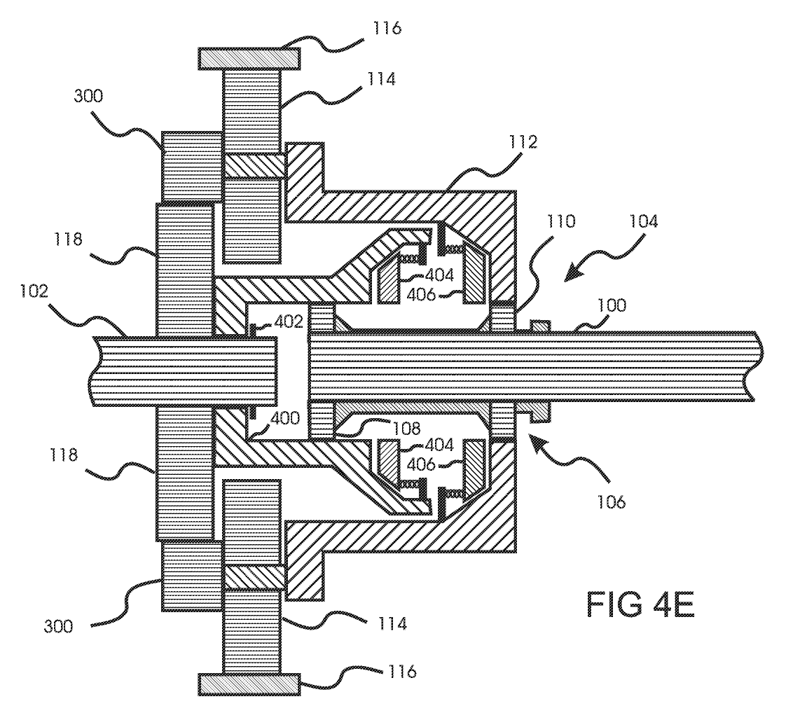

FIG. 4A is a cross sectional view of an embodiment similar to the embodiment of FIG. 3, but including a synchronizer that serves to assist the dog clutch 104 in matching speeds with the second shaft 102 if perfect speed matching cannot be achieved solely through electronic control of the vehicle motor. In this embodiment, the dog clutch 104 and first shaft 100 are shown as being removed from the remainder of the transmission, which is not an actual configuration that would occur during use, but only serves to provide space in the drawing to enumerate the elements included in the synchronizer.

The embodiment of FIG. 4A includes a drum 400 in splined relationship with the second shaft 102 and held in place by snap rings 402. A drum synchronizer ring 404 is frictionally held in place against the drum 400, and a planet carrier synchronizer ring 406 is frictionally held in place against the planet carrier 112. The synchronizer rings are held in place by springs 408 compressed by snap rings 410. In preferred embodiments, the synchronizer rings 404, 406 are made from a material such as brass that is softer than the drum 400 and the planet carrier 112, so as not to cause undue wear to the drum 400 or to the planet carrier 112 when friction occurs between one of the synchronizer rings 404, 406 and the drum 400 or planet carrier 112.

Starting from the “neutral” configuration shown in FIG. 4B, when the dog clutch 104 is slid to the left, the teeth of the drive gear 108 engage with the teeth of the drum synchronizer ring 404, causing the drum synchronizer ring 404 to turn at the rotational speed of the dog clutch 104. If the rotational speed of the dog clutch 104 does not exactly match the rotational speed of the drum 400, this causes friction between the drum synchronizer ring 404 and the drum 400, thereby applying a friction-induced torque to both the drum 400 and the dog clutch 104 until the rotational speeds of the two are matched. Once the rotational speeds are matched, the dog clutch 104 can slide further to the left, thereby engaging the drive gear 108 directly with the drum 400. This is the direct drive configuration, as shown in FIG. 4C.

Starting from the “neutral” configuration shown in FIG. 4B, when the dog clutch 104 is slid to the right, the teeth of the drive gear 108 engage with the teeth of the planet carrier synchronizer ring 406, causing the planet carrier synchronizer ring 406 to turn at the rotational speed of the dog clutch 104. If the rotational speed of the dog clutch 104 does not exactly match the rotational speed of the planet carrier 112, this causes friction between the planet carrier synchronizer ring 404 and the planet carrier 112, thereby applying a friction-induced torque to both the planet carrier 112 and the dog clutch 104 until the rotational speeds of the two are matched. Once the rotational speeds are matched, the dog clutch 104 can slide further to the right, thereby engaging the drive gear 108 directly with the planet carrier 112. This is the overdrive configuration, as shown in FIG. 4D.

In a similar manner to FIG. 2C, when the vehicle is not in motion, the dog clutch 104 can be slid all the way to the left, as shown in FIG. 4E, so as to simultaneously engage the drive gear 108 with the drum 400 and the park gear 110 with the planet carrier 112. This places the transmission in its “park” configuration and prevents any rotation of the first 100 or second 102 shafts.

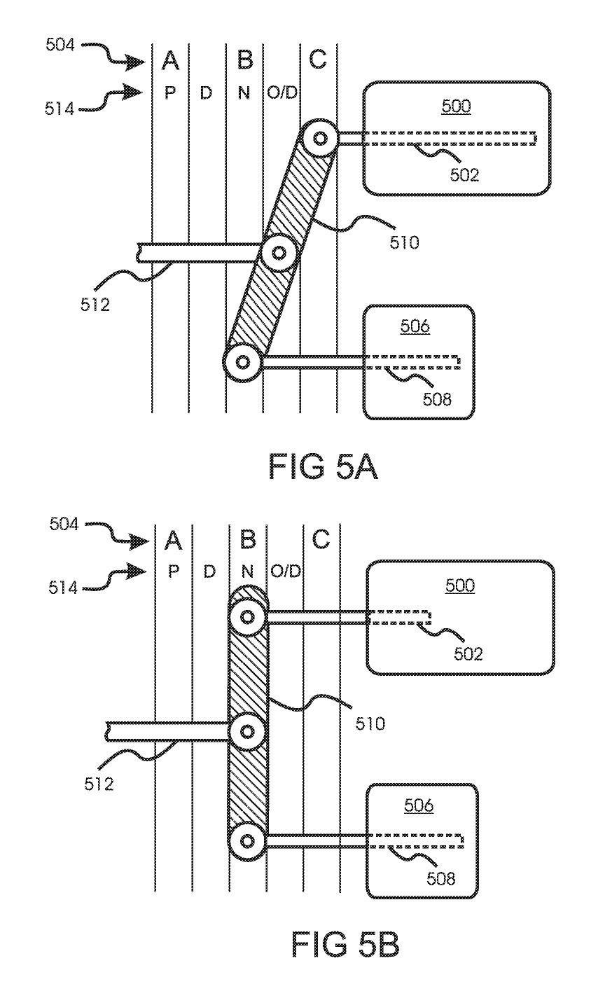

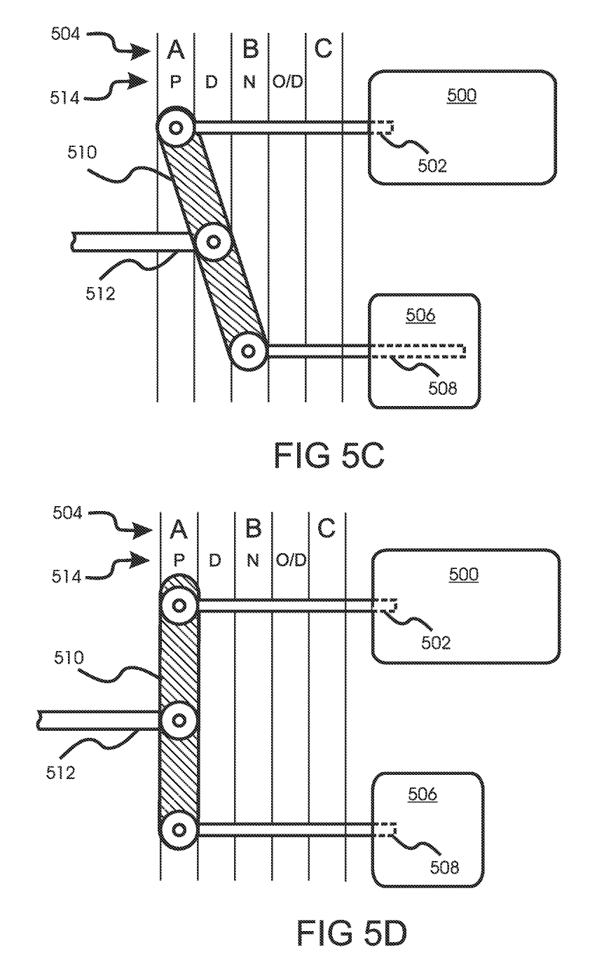

FIGS. 5A through 5D illustrate a dual-servo shift controller of a preferred embodiment. The controller includes a shift servo 500 that is able to move a shift rod 502 linearly among three positions 504, indicated as A, B, and C in the figure. A park servo 506 is also included, and is able to linearly move a park rod 508 between positions A and B. A cross-brace 510 is connected at one end to the shift rod 502 and at the other end to the park rod 508. The center of the cross brace 510 is connected to the dog clutch 104 by a dog clutch shaft 512. In similar embodiments, the center of the cross brace 510 is connected to the dog clutch 104 by a connecting pin or other connecting mechanism known in the art.

The servos are configured so as to allow shifting of the dog clutch 104 among its drive, neutral, and overdrive positions when the park rod 508 is in position B and the shift rod 502 is moved among positions A, B, and C, respectively. The dog clutch 104 can only be moved to its park position when both the park rod 508 and the shift rod 502 are in position A. This configuration simplifies the implementation of safety features as compared to other approaches such as a single, 4-position servo. In preferred embodiments, the park servo is configured so as to move to and/or remain in position B if a malfunction occurs, such as a failure of the servo control circuitry occurring when the park servo is in position B and/or when the vehicle is in motion. FIG. 5A shows the shift controller in its overdrive setting, FIG. 5B shows the shift controller in its neutral setting, FIG. 5C shows the shift controller in its drive setting and FIG. 5D shows the shift controller in its park setting.

Other modifications and implementations will occur to those skilled in the art without departing from the spirit and the scope of the invention as claimed. Accordingly, the above description is not intended to limit the invention except as indicated in the following claims.

What is claimed is:

1. A transmission for use with an electrically powered vehicle, the transmission comprising:
a first shaft;
a second shaft collinear with the first shaft and separated from the first shaft by a gap;
a planetary gear assembly rotationally engaged with the second shaft; and
a dog clutch in splined relationship with the first shaft, the dog clutch being movable among a plurality of positions along a length of the first shaft while remaining rotationally engaged with the first shaft, the dog clutch thereby engaging the first shaft with the second shaft in various rotational speed relationships in accordance with the position of the dog clutch.

2. The transmission of claim 1, wherein the dog clutch is able to move along the length of the first shaft so as to:
in a drive position, engage with the second shaft so as to cause the second shaft to rotate at the same speed as the first shaft;
in an overdrive position, engage with the planetary gear assembly, thereby engaging with the second shaft according to a gear ratio established by the planetary gear assembly, and thereby causing the second shaft to rotate at a speed that is different from the rotational speed of the first shaft; and
in a neutral position, not engage with the second shaft, thereby providing no rotational engagement between the first shaft and the second shaft.

3. The transmission of claim 2, wherein the dog clutch is further able to move along the length of the first shaft so as to:
in a park position, rotationally engage with the second shaft both directly and through the planetary gear assembly, thereby preventing rotation of both the first shaft and the second shaft.

4. The transmission of claim 3, wherein the dog clutch is able to engage with the second shaft by spline engagement when in at least one of the drive position and the park position.

5. The transmission of claim 3, wherein the dog clutch includes a drive gear and a park gear, the drive gear being configured so as to engage with the planetary gear assembly when the dog clutch is in the overdrive position, the park gear being configured so as to engage with the planetary gear assembly when the dog clutch is in the park position.

6. The transmission of claim 5, further comprising a drum that is rotationally engaged with the second shaft, and configured so as to engage with the drive gear when the dog clutch is in the drive position and when the dog clutch is in the park position.

7. The transmission of claim 1, wherein the first shaft is drivable by a motor of the electrically powered vehicle, and the second shaft is able to drive at least one wheel of the electrically powered vehicle.

8. The transmission of claim 1, wherein the second shaft is drivable by a motor of the electrically powered vehicle, and the first shaft is able to drive at least one wheel of the electrically powered vehicle.

9. The transmission of claim 1, wherein the planetary gear assembly includes reduction gears.

10. The transmission of claim 1, wherein the weight of the transmission is distributed in a substantially symmetric manner about the first and second shafts.

11. The transmission of claim 1, wherein the power distribution of the transmission is substantially symmetric about the first and second shafts.

12. The transmission of claim 1, wherein the planetary gear assembly includes a plurality of planetary gears, the planetary gears being positioned within a concentric gap located between a sun gear fixed to the second shaft and an immovable ring gear symmetrically surrounding the sun gear, the planetary gear assembly being engaged with the second shaft by simultaneous engagement of the planetary gears with both the sun gear and the ring gear.

13. The transmission of claim 2, further comprising a synchronizer that is able to synchronize the rotational speeds of the first and second shafts by applying a frictional torque to the first and second shafts until their rotational speeds are matched, thereby facilitating transition of the dog clutch to either of the drive and overdrive positions.

14. The transmission of claim 13, wherein the transmission includes:
a drum that is rotationally engaged with the second shaft;
a planet carrier that is rotationally engaged with the planetary gear set;
a first synchronizer ring that is frictionally engaged with the drum, the first synchronizer ring being rotationally engageable with the dog clutch so as to apply friction to the drum when the dog clutch and the drum are rotating at different speeds, thereby applying a frictional torque to both the dog clutch and to the drum that tends to equalize the rotational speeds of the dog clutch and the drum; and
a second synchronizer ring that is frictionally engaged with the planet carrier, the second synchronizer ring being rotationally engageable with the dog clutch so as to apply friction to the planet carrier when the dog clutch and the planet carrier are rotating at different speeds, thereby applying a frictional torque to both the dog clutch and to the planet carrier that tends to equalize the rotational speeds of the dog clutch and the planet carrier.

15. The transmission of claim 14, wherein at least one of the synchronizer rings is made from a synchronizer material that is selected so as to minimize frictional wear to cooperative elements in the transmission.

16. The transmission of claim 15, wherein the synchronizer material is brass.

17. The transmission of claim 3, further comprising a dual-servo shift controller, the dual-servo shift controller including:
a shift servo that is able to move a shift rod linearly among a first shift position, a second shift position, and a third shift position, the movement of the shift rod being parallel to both the first and second shafts;
a park servo that is able to move a park rod linearly between a park position and a run position, the movement of the park rod being parallel to both the first and second shafts; and
a cross-brace having a first end attached to the shift rod, a second end attached to the park rod, the dog clutch being attached to the cross-brace at a clutch attachment point located between the first end and the second ends,
the shift servo, park servo, and cross-brace being configured so as to move the dog clutch among the drive position, the overdrive position, and the neutral position when the shift servo is moved among the shift positions and the park servo is held in the run position,
the shift servo, park servo, and cross-brace being configured so as to allow the dog clutch to be moved to the park position only when the park servo is in the park position.

18. The transmission of claim 17, wherein:
the dog clutch is moved to the drive position when the shift rod is in the first shift position and the park rod is in the run position;
the dog clutch is moved to the neutral position when the shift rod is in the second shift position and the park rod is in the run position;
the dog clutch is moved to the overdrive position when the shift rod is in the third shift position and the park rod is in the run position; and
the dog clutch is moved to the park position when the shift rod is in the first shift position and the park rod is in the park position.

19. The transmission of claim 17, wherein the park servo is configured so as to remain in its run position if the park servo is in its run position and a transmission malfunction occurs.

20. The transmission of claim 17, further comprising at least one safety feature that is configured so as to inhibit the park rod from moving to the park position if the electrically powered vehicle is moving.
